(19) United States
(12) Patent Application Publication
(10) Pub. No.: US 2015/0279520 A1
(43) Pub. Date: Oct. 1, 2015

(54) CONDUCTIVE MEMBER, AND CONDUCTIVE MEMBER MANUFACTURING METHOD

(71) Applicant: YAZAKI CORPORATION, Tokyo (JP)

(72) Inventor: Keisuke KODA, Shizuoka (JP)

(21) Appl. No.: 14/723,600

(22) Filed: May 28, 2015

Related U.S. Application Data
(63) Continuation of application No. PCT/JP2013/079763, filed on Nov. 1, 2013.

(30) Foreign Application Priority Data
Nov. 29, 2012 (JP) 2012-260898

(51) Int. Cl. H01B 13/18

(52) U.S. Cl. CPC H01B 13/18

(57) ABSTRACT

A conductive member includes a bus bar that is formed of a plate-shaped conductive material and an insulating material that coats the bus bar. The insulating material is formed of a resin cured by ultraviolet rays.

### CROSS REFERENCE TO RELATED APPLICATIONS

This application is a continuation application of International Application No. PCT/JP2013/079763, filed on Nov. 1, 2013, which claims priority to Japanese Patent Application No. 2012-260898, filed on Nov. 29, 2012, the entire contents of which are incorporated by references herein.

### BACKGROUND

1. Technical Field

The present invention relates to a conductive member that is connected to a power supply such as a battery and that feeds electricity to electrical components and the like and a conductive member manufacturing method.

2. Description of the Related Art

Conventionally, in a power supply circuit or the like, a conductive member (also referred to as a bus bar module) is used that is connected to a power supply such as a battery and that feeds electricity to electrical components and the like. This type of conductive member includes a bus bar that is formed with a plate-shaped conductive material (for example, copper, copper alloy or aluminum). A plurality of bus bars is arranged in a plate thickness direction thereof. In each of the bus bars, punching processing with a press is performed, and connection portions are provided in both end portions.

Conductive members are preferably arranged as close as possible to achieve space saving, whereas it is necessary to ensure insulation properties between bus bars. For example, as shown in FIGS. 7A to 7D, a technique (hereinafter, a first conventional example) for insulating bus bars B with insulating materials D such as a resin cassette, insulating paper, an insulating tape and a resin mold is known (see Japanese Patent Laid-Open Publication No. 2002-84621). A technique (hereinafter, a second conventional example) for coating the surrounding of the bus bars B with an insulating material is also known (see Japanese Patent Laid-Open Publication No. 2006-24449).

### SUMMARY OF THE INVENTION

However, in the first conventional example described above, as shown in FIG. 7A, when the bus bars B are insulted with the resin cassette, it is necessary to provide opening portions V for the insertion of the bus bars B. Hence, it is inevitable to secure a predetermined space (creepage distance) on the side of the opening portions V, and thus an arrangement space is increased.

As shown in FIGS. 7B and 7C, when the bus bars B are insulted with the insulating paper or the insulating tape, a worker needs to fit or wind the insulating paper or the insulating tape. Hence, as the manufacturing of the conductive member becomes more complicated, the manufacturing cost of the conductive member is increased.

As shown in FIG. 7D, when the bus bars B are insulated with the resin mold, a void is produced at the time of insert molding, and thus the insulation performance may be lowered, and a mold cost is needed, and thus the manufacturing cost of the conductive member is increased.

Furthermore, as shown in FIGS. 7A and 7D, when the bus bars B are insulated with the resin cassette or the resin mold, the isolator D has a large volume, and thus the arrangement space is increased, and the weight of the conductive member is increased.

Although in the second conventional example described above, an illustration is omitted, the size of a facility used for the coating is increased, and thus the initial facility cost is increased, with the result that the manufacturing cost of the conductive member is increased.

It is an object of the present invention to provide a conductive member that ensures an insulation performance, that can reduce its weight and an arrangement space and that can reduce a manufacturing cost and a conductive member manufacturing method.

A first aspect of the present invention is a conductive member including: a bus bar that is formed of a conductive material; and an insulating material that is formed of a resin cured by ultraviolet rays and that coats the bus bar.

A second aspect of the present invention is a conductive member manufacturing method for manufacturing a conductive member including a bus bar that is formed of a conductive material and an insulating material that coats the bus bar, the method including: coating a surface of the bus bar with the insulating material formed of a resin cured by ultraviolet rays; and curing the insulating material by applying ultraviolet rays to the insulating material with which the surface of the bus bar is coated.

The conductive member manufacturing method according to the second aspect may include molding a bus bar continuous member in which the bus bars are continuously connected in a longitudinal direction, before the coating of the insulating material. The bus bar continuous member may be coated with the insulating material every predetermined interval.

According to the present invention, it is possible to provide a conductive member that ensures an insulation performance, that can reduce its weight and an arrangement space and that can reduce a manufacturing cost and a conductive member manufacturing method.

### BRIEF DESCRIPTION OF THE DRAWINGS

FIG. 1 is a perspective view showing a conductive member according to an embodiment of the present invention;

FIG. 2A is a side view showing the conductive member according to the present embodiment.

FIG. 2B is a cross-sectional view taken along a line A-A in FIG. 2A;

FIG. 3 is a schematic diagram showing various types of devices used in a conductive member manufacturing method according to the present embodiment;

FIGS. 4A to 4E are schematic diagrams showing the conductive member manufacturing method according to the present embodiment (part 1);

FIGS. 5A to 5C are schematic diagrams showing the conductive member manufacturing method according to the present embodiment (part 2);

FIGS. 6A to 6D are schematic diagrams showing a conductive member manufacturing method according to another embodiment of the present invention; and

FIGS. 7A to 7D are cross-sectional views each showing a conductive member according to a first conventional example.

### DESCRIPTION OF THE EMBODIMENTS

A conductive member according to an embodiment of the present invention and a conductive member manufacturing method will be described with reference to drawings. In the following illustration of the drawings, the same or similar parts are identified with the same or similar symbols. However, it should be noted that the drawings are schematic, and the ratio of each dimension and the like are different from those in reality. Hence, specific dimensions and the like need to be determined with reference to the following description. The relationship of dimensions between the drawings and the ratio thereof may be partially different.

(Configuration of the Conductive Member)

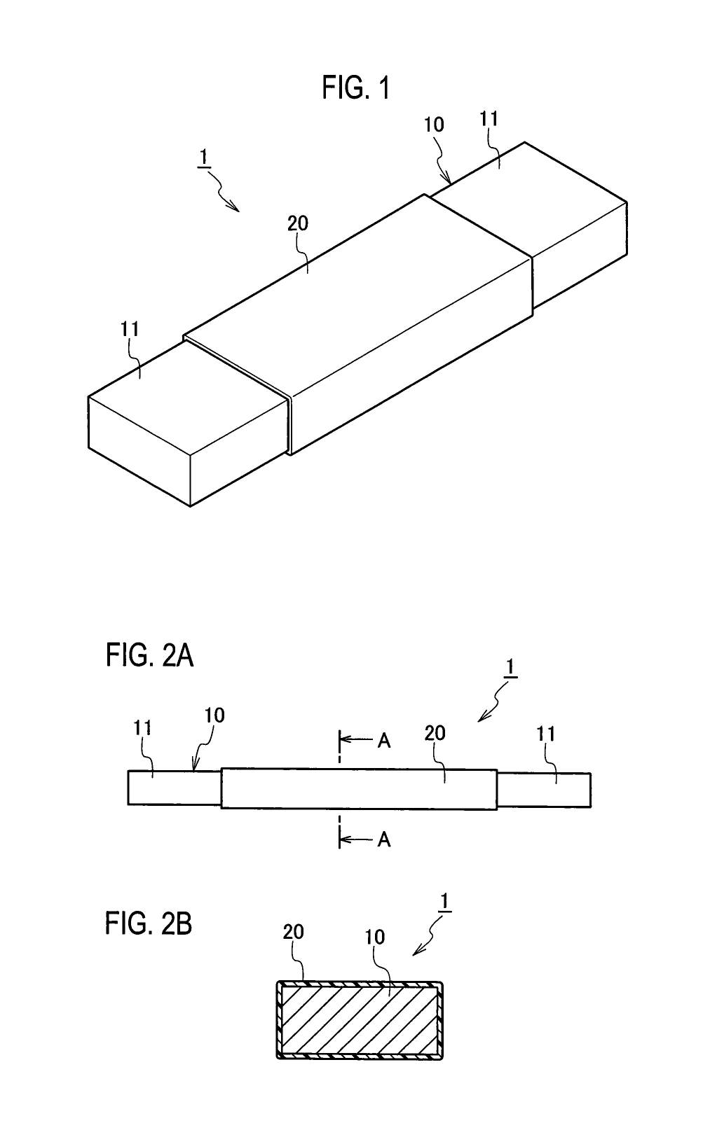

The configuration of the conductive member 1 according to the present embodiment will be described with reference to drawings. FIG. 1 is a perspective view showing the conductive member 1 according to the present embodiment. FIG. 2A is a side view showing the conductive member 1 according to the present embodiment, and FIG. 2B is a cross-sectional view taken along a line A-A in FIG. 2A. Although the conductive member 1 is suitably applied to a power supply circuit or the like in which a relatively high voltage is applied to make its insulation properties problematic, it can also be applied to other electrical circuits to which a current is fed.

As shown in FIGS. 1 and 2, the conductive member 1 is formed with a bus bar 10 and an insulating material 20 that coats the bus bar 10.

The bus bar 10 is arranged in plural number in a plate thickness direction thereof. In the figure, only one bus bar 10 is shown, and the other bus bars 10 are omitted. The bus bar 10 is formed of a conductive material whose cross section is plate-shaped. Examples of the conductive material include copper, a copper alloy and aluminum. At both ends of the bus bar 10, connection portions 11 that are connected to a power supply such as a battery or various types of electrical components and the like.

The insulating material 20 is provided in the entire region of the bus bar 10 except the connection portions 11. The insulating material 20 is formed of a resin that is cured by ultraviolet rays. Examples of the resin include an epoxy acrylate, a urethane acrylate, a polyester acrylate, a copolymerization-based acrylate, a polybutadiene acrylate, a silicone acrylate, an amino resin acrylate, an alicyclic epoxy resins, a glycidyl ether epoxy resin, a urethane vinyl ether, a polyester vinyl ether, an acrylate monomer and these composites.

The insulating material 20 coats the bus bar 10 other than the connection portions 11. The film thickness of the insulating material 20 is determined as necessary according to the type of insulating material 20 as long as the insulation properties of the bus bar 10 are ensured, and is, for example, several to several hundreds of micrometers. For example, the insulating material 20 is formed of a composite of an epoxy acrylate, a urethane acrylate and an acrylate monomer, and its film thickness is set at about 100 to 800 μm.

(Conductive Member Manufacturing Method)

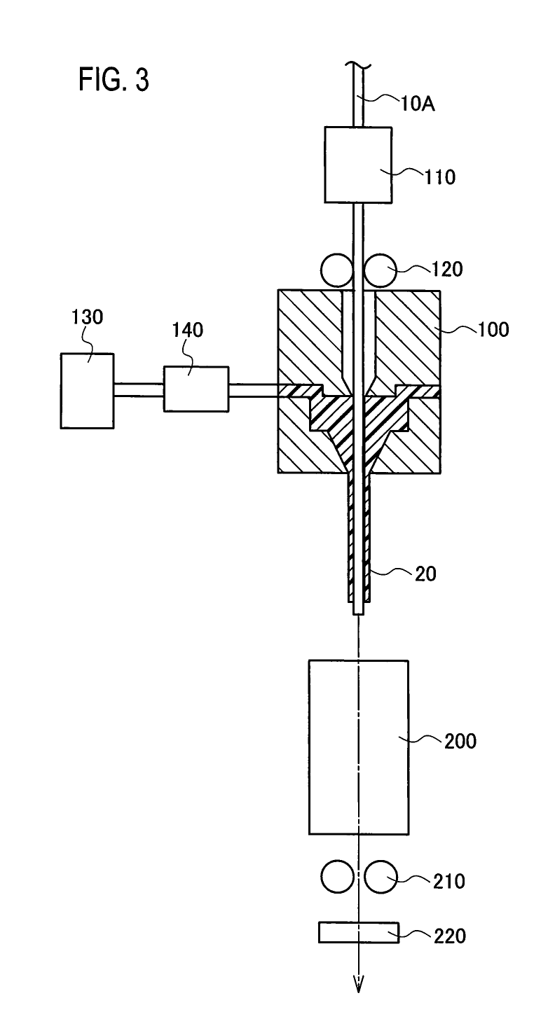

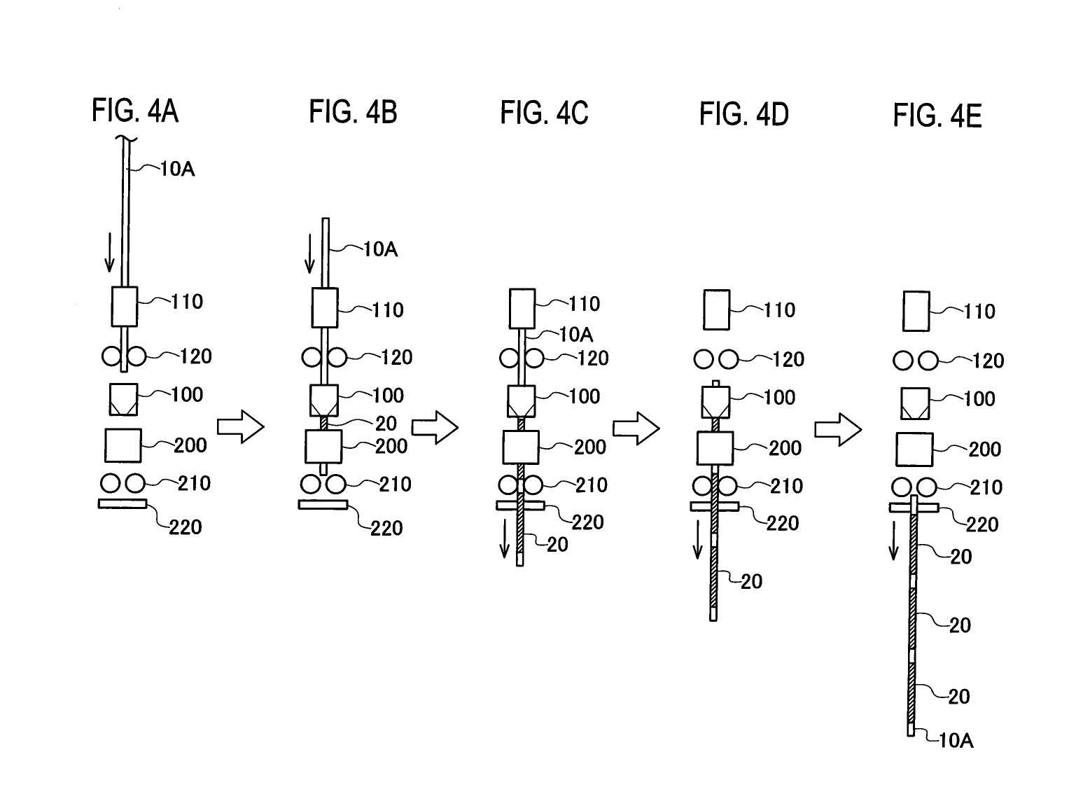

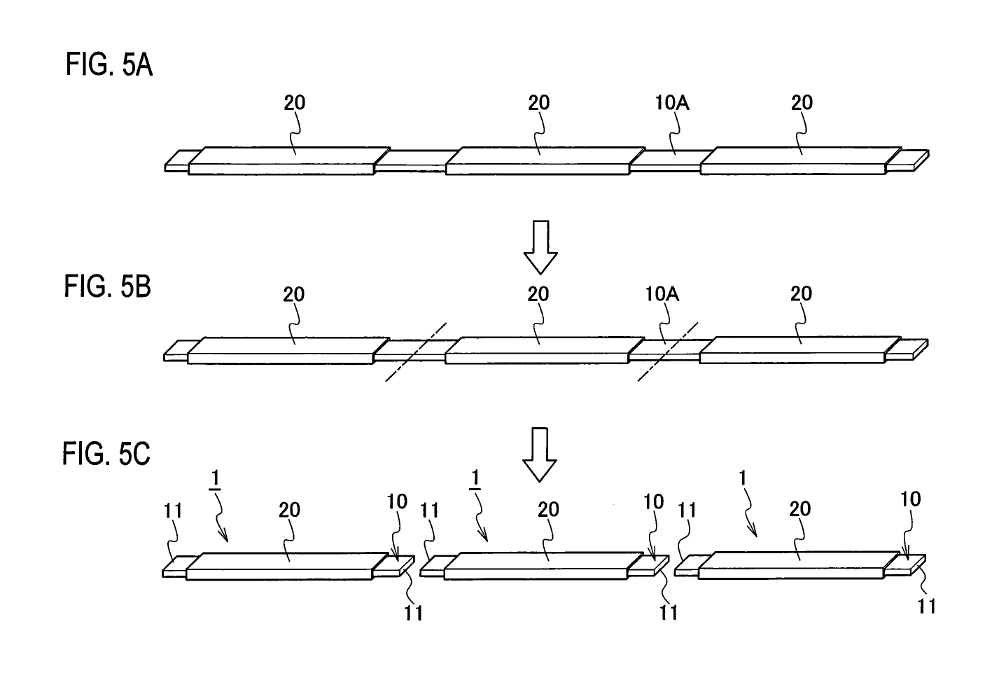

The conductive member manufacturing method 1 described above will then be described with reference to drawings. FIG. 3 is a schematic diagram showing various types of devices used in the conductive member manufacturing method 1 according to the present embodiment. FIGS. 4A to 4E and 5A to 5C are schematic diagrams showing the conductive member manufacturing method 1 according to the present embodiment.

The manufacturing method of the conductive member 1 includes: a step A of molding a bus bar continuous member 10A in which the bus bars 10 are continuously connected in a longitudinal direction by performing punching with a press; a step B of coating the surface of the bus bar continuous member 10A (bus bars 10) with the insulating material 20; a step C of curing the insulating material 20 by applying ultraviolet rays to the insulating material 20 with which the surface of the bus bar continuous member 10A is coated; and a step D of cutting the bus bar continuous member 10A to manufacture the bus bars 10.

In the step A, a press device (not shown) is used that performs punching on the conductive material to mold the bus bar continuous member 10A, In the step B, as shown in FIGS. 3 and 4A to 4E, a coating device 100 is used that coats the surface of the bus bar continuous member 10A with the insulating material 20. In the step C, as shown in FIGS. 3 and 4A to 4E, an ultraviolet application device 200 is used that applies ultraviolet rays to the insulating material 20. In the step D, a cutting device (not shown) is used that cuts the bus bar continuous member 10A.

Specifically, as shown in FIGS. 3, 4A and 4B, the bus bar continuous member 10A molded with the press device (not shown) from the conductive material is guided by a guide 110 and a roller 120 to the coating device 100. Then, the bus bar continuous member 10A is passed through the coating device 100, and thus its surface is coated with the insulating material 20.

Here, as shown in FIG. 3, the insulating material 20 is fed every predetermined time with a liquid feed pump 140 from a tank 130 in which the insulating material 20 is stored. Examples of the method of feeding the insulating material 20 from the liquid feed pump 140 to the coating device 100 every predetermined time includes: intermittently switching the power of the liquid feed pump 140; and intermittently blocking the inlet or the outlet of the liquid feed pump 140 with a shutter or the like. In this way, the bus bar continuous member 10A is coated with the insulating material 20 every predetermined interval (so-called intermittently).

Then, as shown in FIGS. 3, 4B and 4C, the bus bar continuous member 10A coated with the insulating material 20 is passed through the ultraviolet application device 200, and thus the insulating material 20 is cured. As shown in FIGS. 3, 4D and 4E, the bus bar continuous member 10A whose insulating material 20 has been cured is passed through a take-up roller 210, a diameter monitor 220 and the like. Thereafter, as shown in FIGS. 5A to 5C, the parts (that is, the connection portions 11) of the bus bar continuous member 10A that are not coated with the insulating material 20 are cut with the cutting device (not shown), and thus the conductive members 1 are manufactured.

(Action and Effects)

In the present embodiment described above, the insulating material 20 is formed of a resin that is cured by ultraviolet rays. In this way, unlike a conventional resin mold, a void is prevented from being produced, and it is possible to stably obtain a predetermined insulation performance according to the type and the film thickness of the insulating material 20. As compared with a case where winding is manually performed with a conventional insulating tape or the like, it is possible to inexpensively manufacture the conductive member with high productivity.

In the present embodiment, the insulating material 20 can be set such that the film thickness of the resin that is cured by ultraviolet rays, that is, the insulating material 20 is small. Hence, as compared with a conventional resin cassette or resin mold, its volume is decreased, and it is not necessary to secure a creepage distance. Hence, it is possible to significantly save the arrangement space and facilitate a reduction in the weight of the conductive member 1.

In the present embodiment, while the bus bars 10 coated with the insulating material 20 are overlaid on each other, they can be integrally adhered with an adhesive, it is easy to perform an arrangement operation on an electrical circuit and the like and it is possible to arrange the bus bars 10 in a small space in a compact manner.

In the present embodiment, immediately after the bus bar continuous member 10A is coated with the insulating material 20, the insulating material 20 is cured with the ultraviolet application device 200. Hence, it is possible to prevent the insulation performance from being lowered without a reduction in the thickness of the coated film of an edge part at the end of the insulating material 20.

Moreover, it is possible to coat the bus bar continuous member 10A with the insulating material 20 every predetermined interval. Hence, since as compared with a method of electrostatic powder coating, the connection portions 11 are not coated with the insulating material 20, it is not necessary to perform masking, with the result that it is possible to continuously form the conductive members 1. Thus, it is possible to realize both a reduction in the manufacturing cost of the conductive member 1 and a reduction in the manufacturing time.

### Other Embodiments

Although as described above, the details of the present invention have been disclosed through the embodiment of the present invention, it should not be understood that the discussion and the drawings which form parts of this disclosure limit the present invention. Various variations, examples and operation technologies will become clear from this disclosure to the person skilled in the art.

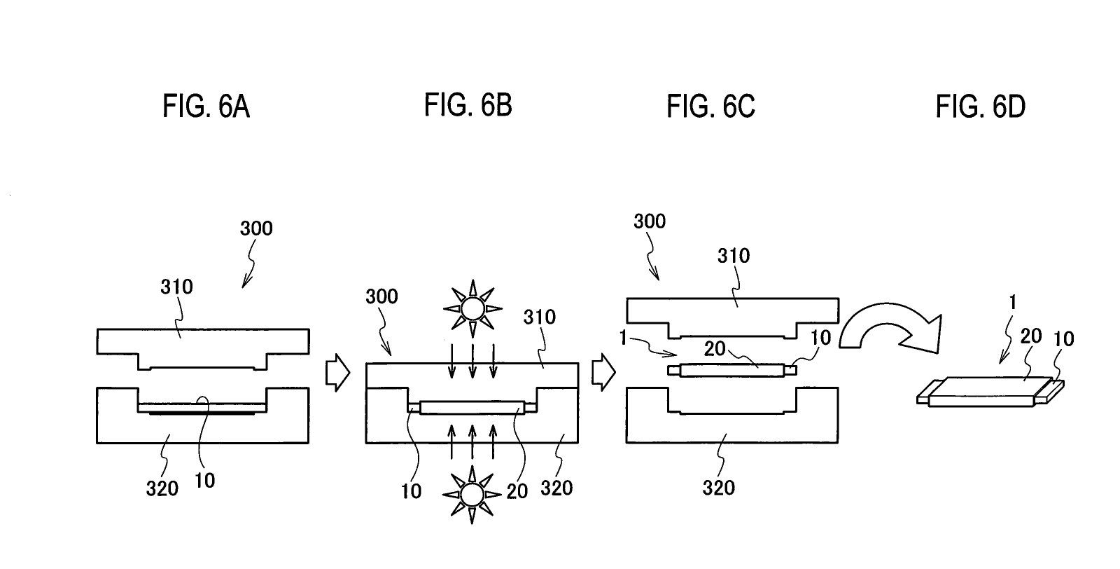

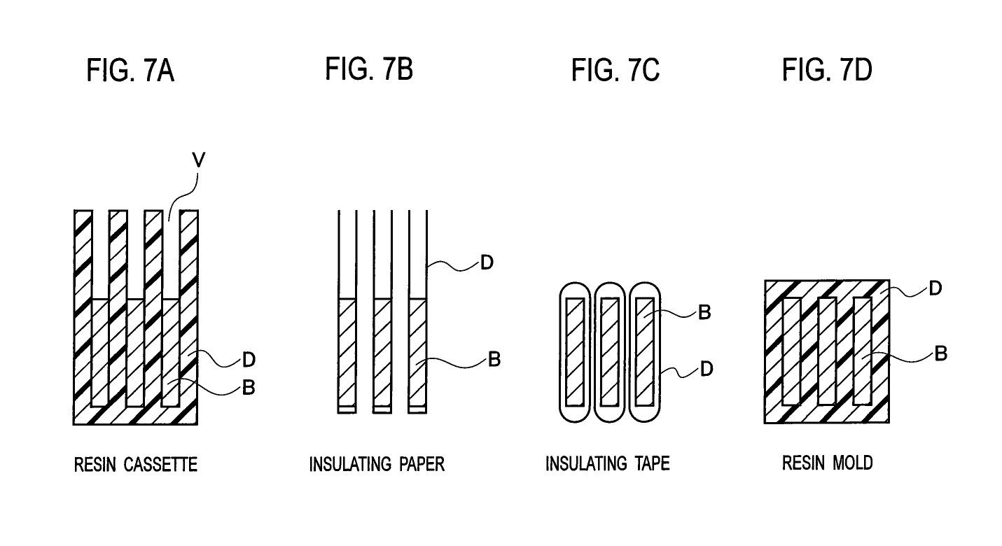

For example, the embodiment of the present invention can be changed as follows. Specifically, the conductive member 1 is not limited to the manufacturing method described in the embodiment, and the conductive member 1 may be manufactured with another manufacturing method. For example, as shown in FIGS. 6A to 6D, the conductive member 1 may be manufactured with a transparent mold 300 (an upper mold 310 and a lower mold 320). Here, the insulating material 20 is cured by the application of ultraviolet rays from the outside of the transparent mold 300.

Although in description of the step A in the manufacturing method of the conductive member 1, the punching with the press is performed to mold the bus bar continuous member 10A, there is no restriction on this. For example, slit processing may be performed to mold the bus bar continuous member 10A.

It is natural that the shape of the bus bar 10, the film thickness of the insulating material 20 and the like are not limited to those described in the embodiment and can be set as necessary. For example, although in the above description, the bus bar 10 is plate-shaped in cross section, there is no restriction on this. The bus bar 10 may be circular or triangular in cross section.

Although the insulating material 20 is provided so as to coat the entire region of the surface of the bus bar 10 other than the connection portions 11, there is no restriction on this. A part where the insulation performance is not problematic is not always needed to be coated.

As described above, the present invention naturally includes various embodiments that are not described herein. Hence, the technical scope of the present invention is determined only by subject matter appropriate to the above description and according to the scope of claims.

What is claimed is:

1. A conductive member manufacturing method for manufacturing a conductive member including a bus bar that is formed of a conductive material and an insulating material that coats the bus bar, the method comprising:
molding a bus bar continuous member in which the bus bars are continuously connected in a longitudinal direction;
coating a surface of the bus bar with the insulating material formed of a resin cured by ultraviolet rays after the molding of the bus bar continuous member; and
curing the insulating material by applying ultraviolet rays to the insulating material with which the surface of the bus bar is coated,
wherein the coating of the insulating material includes coating the bus bar continuous member with the insulating material every predetermined interval.
